(19) United States
(12) Patent Application Publication
(10) Pub. No.: US 2009/0135024 A1
(43) Pub. Date: May 28, 2009

(54) DISPLAY CONTROL SYSTEM OF TRAFFIC LIGHT AND DISPLAY METHOD

(76) Inventors: Jin-gu Park, Incheon (KR); Young-seok Yang, Gyeongsangnam-do (KR); Jung-hae Park, Gyeongsangnam-do (KR)

Correspondence Address: PARK LAW FIRM, 3255 WILSHIRE BLVD, SUITE 1110, LOS ANGELES, CA, 90010, US

(21) Appl. No.: 12/063,415

(22) PCT Filed: Mar. 16, 2007
(86) PCT No.: PCT/KR2007/001304

§ 371 Date: Jun. 4, 2008

(30) Foreign Application Priority Data
Mar. 17, 2006 (KR) 10-2006-0025063
Jan. 19, 2007 (KR) 10-2007-0005921

(51) Int. Cl. G08G 1/096; G08G 1/095

(52) U.S. Cl. 340/929; 340/907

(57) ABSTRACT

Provided are a traffic light display control system and a display method thereof capable of accurately predicting a warning from a yellow light as a signal for alerting drivers to a residual time of a green light and a prepare-to-stop light, and providing traffic instruction. The traffic light display control system, which is controlled by a central control station for controlling display of a traffic light installed at each road, includes: an auxiliary traffic light as a first display part; a main traffic light as a second display part used in a conventional traffic light system; a memory part for storing a command value for turning ON and OFF each display lamp of the auxiliary traffic light and the main traffic light at predetermined time intervals; and a controller for controlling to turn ON and OFF the auxiliary traffic light and the main traffic light at pre-determined time intervals depending on the command value stored in the memory part, wherein the auxiliary traffic light is installed over the main traffic light, the auxiliary traffic light comprising first to fifth display lamps, and the first to fifth display lamps are sequentially changed from green into yellow to block entry of a vehicle into a crossroad.

### TECHNICAL FIELD

The present invention relates to a display control system of a traffic light and a display method thereof, and more particularly, to a display control system of a traffic light and a display method thereof using an auxiliary traffic light installed on an upper part of a main traffic light of a crossroad and a crosswalk, and alerting drivers and pedestrians to an auxiliary traffic light for assisting a main traffic light, the auxiliary traffic light capable of displaying a yellow light that accurately indicates residual time of a green light and a prepare-to-stop light to accurately control traffic.

### BACKGROUND ART

Generally, a traffic light is installed at a crossroad or a crosswalk to instruct traffic of vehicles and pedestrians such that the vehicles and the pedestrians can smoothly pass the crossroad or the crosswalk. The traffic light includes a red light as a stop signal, a yellow light as a prepare-to-stop signal, a green light as a drive signal, and an arrow sign as a turn signal.

A conventional traffic light is generally installed on or suspended by a separate post, and has white lamps installed in a predetermined shape of a main body, and red, yellow and green glass covers installed in front of the white lamps. When the lamps of the traffic light are lighted depending on an output signal from a traffic control center or a control box for controlling a traffic light of a localized area, light from the lamps emits through the glass covers to display drive, stop, and prepare-to-stop signals.

However, since the conventional traffic light displays the drive, stop, and prepare-to-stop signals by lighting the lamps, when any one lamp is out of order, it is imp ossible to display the corresponding signal, thereby causing confusion. In addition, since its signal display area is too small and the glass covers reflect sunlight, it can be difficult to discriminate the drive, stop, and prepare-to-stop signals in daytime.

Further, the conventional traffic light cannot alert drivers to a residual time to a signal change, possibly causing traffic accidents. That is, a driver accelerating his/her vehicle to go through a crossroad on a green light has to stop suddenly when the signal is changed to a prepare-to-stop signal, thereby possibly causing traffic accidents such as collisions, and so on.

Furthermore, in order to provide traffic information regarding traffic accidents, delay and congestion of vehicles, and so on, to smoothly relieve the delay and congestion of the traffic, a separate display board for providing traffic information should be installed, in addition to the traffic light for displaying the drive, stop, and prepare-to-stop signals.

A residual time display device for a pedestrian light has been developed to provide a residual time of the pedestrian light to a pedestrian.

FIG. 1 shows a conventional residual time display device for a pedestrian light, which is currently installed and used.

The residual time display device for a pedestrian light functions as an auxiliary light for a traffic light, such that a pedestrian crosses the crosswalk with peace of mind. Especially at night, when traffic volume is low, pedestrians who are familiar with a blinking pedestrian light and unaware of a residual time to a red light, may cross the crosswalk just before the signal is changed to the red light, and thus the pedestrians may unexpectedly be involved in a traffic accident with moving vehicles. Moreover, elderly people or the disabled, generally being slower than the general populace, are likely to be exposed to the risk of traffic accidents in a defenseless state after entering the crosswalk. If pedestrians could know the residual time to the green light of the pedestrian light, such accidents could be prevented. For this reason, and in order to reduce a feeling of apprehension for pedestrians and prevent accidents at crosswalks, the Korean National Police Agency performed a survey of public opinion and a feasibility study on the basis of test installation results for six months from December, 1998, and finally announced the Enforcement Ordinance of installation of “a residual time display device of a pedestrian light (as shown in FIG. 1), on Jan. 12, 2000.

In order to accomplish the above purpose, various technical attempts have been made. For example, Korean Patent Laid-open Publication No. 2000-18157 discloses a residual time display device for a traffic light capable of displaying a residual time of a traffic light or a pedestrian light to prevent traffic accidents at crossroads and crosswalks, respectively.

In order to solve the disadvantages and problems of the conventional arts, Korean Patent Laid-open Publication No. 2004-54156, published on Jun. 25, 2004, discloses a technology of a display device for alerting a green light residual time of a traffic light to a driver.

Specifically, the above signal display device uses a microcomputer system having a compatible and simple hardware structure, a compact size, a low price, and high reliability on the basis of analyzed results of signal generating period and drive characteristics of the conventional traffic light controller, thereby providing a novel controller and display device capable of displaying a residual time interlocking with a green light and a left turn signal of a traffic light for vehicles.

More specifically, as shown in FIG. 2, an automatic standby time display device of a traffic light includes a signal input part 10 for converting conventional traffic lights into a format appropriate to a microcomputer to input the converted signal into a controller of the microcomputer, a manipulation part 20 including a switch and an auxiliary circuit for separately setting a time, a microcomputer system 30 for controlling the signals input from the signal input part and the manipulation part, storing the signal, and programming display of the signal, a signal display part 50 for displaying a residual time using a transmitted time-related signal, and an interface drive part 40 for driving the signal display part depending on a residual time display signal of the traffic light output from the microcomputer. Since the standby time display device is on the basis of the microcomputer system to enable ready modification and expansion of its functions without structural modification of the conventional traffic light, it is possible to accurately alert pedestrians and drivers to a standby time of the traffic light to reduce errors in judgment of the traffic lights due to hastiness, frustration or boredom, thereby increasing traffic safety and preventing traffic accidents.

In addition, as shown in FIG. 3, Korean Patent Laid-open Publication No. 2002-4189, published on Jan. 16, 2002, discloses a structure in which an LED panel 15 is connected to an LED drive part 16 to switch red, green and yellow light emitting diodes using a drive power of a power supply 18 to blink the light emitting diodes, the LED drive part 16 selectively blinks the light emitting diodes 14 depending on a traffic light control signal such as drive, stop, prepare-to-stop signals, and so on, or a traffic information signal applied from a traffic control center or a control box 19 for controlling a traffic light of a local area, and when the traffic light control signal or the traffic information signal is applied from the traffic control center or the control box 19 for controlling a traffic light of a local area, a controller 17 outputs a control signal corresponding thereto to control operation of the LED drive part 16 and selectively supply a drive power from the power supply 18 to the red, green and yellow light emitting diodes, thereby blinking the light emitting diodes.

Though the above conventional arts disclose technologies of blinking a main traffic light, because prediction of a residual time is uncertain, the prediction is useless. In addition, though the conventional arts disclose technologies of displaying a residual time interlocking with a green light and a left turn signal of the traffic light, it is less effective for a driver driving a vehicle at a certain speed to recognize the signals.

### DISCLOSURE OF INVENTION

### Technical Problem

The present invention is directed to a traffic light display control system and a display method thereof capable of preventing confusion of a driver driving a vehicle due to an auxiliary traffic light by constituting the auxiliary traffic light such that a signal system of the auxiliary traffic light is operated in the same manner as a main traffic light.

The present invention is also directed to a traffic light display control system and a display method thereof capable of readily discriminating the traffic lights by constituting the size, number, and shape of auxiliary traffic lights differently from the main traffic lights.

### Technical Solution

One aspect of the present invention provides a traffic light display control system, controlled by a central control station and controlling display of a traffic light installed at each road. The display control system includes an auxiliary traffic light as a first display part, a main traffic light as a second display part used in a conventional traffic light system, a memory part for storing a command value for turning ON and OFF each display lamp of the auxiliary traffic light and the main traffic light at pre-determined time intervals, and a controller for controlling to turn ON and OFF the auxiliary traffic light and the main traffic light at predetermined time intervals depending on the command value stored in the memory part, wherein the auxiliary traffic light is installed over the main traffic light, and the auxiliary traffic light includes first to fourth display lamps. The first to fourth display lamps of the auxiliary traffic light are all turned ON in the same color when the main traffic light is red, arrow, yellow or green, the display lamps are sequentially changed from green into yellow to block entry of a vehicle into a crossroad before a drive signal of the main traffic light is changed. The auxiliary traffic light further includes a fifth display lamp, the first to fifth display lamps sequentially changed from green into yellow to block entry of a vehicle into a crossroad. The main traffic light has a circular shape, and the first to fifth display lamps of the auxiliary traffic light have an oval shape.

In the traffic light display control system in accordance with the present invention, when the green light of the main traffic light is turned ON, the first to fourth display lamps of the auxiliary traffic light may be sequentially turned ON in yellow.

In the traffic light display control system in accordance with the present invention, when the yellow light of the main traffic light is turned ON, the first to fifth display lamps of the auxiliary traffic light may be simultaneously turned ON in yellow.

In the traffic light display control system in accordance with the present invention, when the red light of the main traffic light is turned ON, the first to fifth display lamps of the auxiliary traffic light may be simultaneously turned ON in red.

Another aspect of the present invention provides a traffic light display control system controlled by a central control station and controlling display of a traffic light installed at each road. The display control system includes a traffic light having first and second display parts and used in a conventional traffic light system, a memory part for storing a command value for turning ON and OFF each display lamp of the traffic light at predetermined time intervals, and a controller for controlling to turn ON and OFF the traffic light at predetermined time intervals depending on the command value stored in the memory part, wherein the first and second display parts include first to eighth display lamps. The first to fourth display lamps of the first display part are left turn instruction lights, and the fifth to eighth display lamps of the second display part are drive instruction lights. The first to eight display lamps of the traffic light are sequentially turned ON in order of the first to fourth display lamps of the first display part, and the fifth to eight display lamps of the second display part are turned ON in yellow simultaneously with turning OFF of a left turn light and a green light in order to block entry of a vehicle into a crossroad.

Still another aspect of the present invention provides a display control method of a traffic light using a display control system controlled by a central control station and controlling display of a traffic light installed at each road. The display control system includes an auxiliary traffic light as a first display part having first to fifth display lamps, a main traffic light as a second display part used in a conventional traffic light system, a memory part for storing a command value for turning ON and OFF each display lamp of the auxiliary traffic light and the main traffic light at predetermined time intervals, and a controller for controlling to turn ON and OFF the auxiliary traffic light and the main traffic light at predetermined time intervals depending on the command value stored in the memory part. The display control method of the traffic light includes: a first step of simultaneously turning ON the first to fifth display lamps of the auxiliary traffic light in red when a red light of the main traffic light is turned ON; a second step of turning ON the first display lamp of the auxiliary traffic light in red and simultaneously turning ON the second to fifth display lamps into left turn arrows when a left turn light of the main traffic light is turned ON; a third step of sequentially changing the second to fifth display lamps of the auxiliary traffic light from left turn arrows into yellow before the left turn light of the main traffic light is turned OFF; a fourth step of simultaneously turning ON the second to fifth display lamps of the auxiliary traffic light in yellow when a yellow light of the main traffic light is turned ON; a fifth step of simultaneously turning ON the first to fifth display lamps of the auxiliary traffic light in green when a green light of the main traffic light is turned ON; and a sixth step of sequentially changing the first to fifth display lamps of the auxiliary traffic light from green into yellow before the green light of the main traffic light is turned OFF, wherein the first to sixth steps are repeatedly performed. The main traffic light has a circular shape, and the first to fifth display lamps of the auxiliary traffic light have an oval shape.

Yet another aspect of the present invention provides an auxiliary traffic light for predicting a signal change controlled by a central control station and installed at a road and spaced apart from a main traffic light by a predetermined distance to alert drivers to a state of the main traffic light that is installed at the road. The auxiliary traffic light includes a memory part for storing a command value for turning ON and OFF display lamps of the auxiliary traffic light and the main traffic light at predetermined time intervals, and a controller for controlling to turn ON and OFF the auxiliary traffic light and the main traffic light depending on the command value stored in the memory part at predetermined time intervals, wherein the auxiliary traffic light further includes first to fifth display lamps, the first to fifth display lamps of the auxiliary traffic light are all turned ON in the same color when the main traffic light is red, arrow, yellow or green, the display lamps are sequentially changed form green into yellow to block entry of a vehicle into a crossroad before a drive signal of the main traffic light is changed, the first to fifth display lamps are sequentially changed from green into yellow to block entry of a vehicle into a crossroad, and the first to fifth display lamps of the auxiliary traffic light have an oval shape.

Yet another aspect of the present invention provides a method of controlling and displaying an auxiliary traffic light for predicting a signal change controlled by a central control station and installed at a road and spaced apart from a main traffic light by a predetermined distance to alert drivers to a state of the main traffic light installed at the road. The main traffic light includes an auxiliary traffic light including first to fifth display lamps, a memory part for storing a command value for turning ON and OFF display lamps of the auxiliary traffic light at predetermined time intervals, and a controller for controlling to turn ON and OFF the auxiliary traffic light depending on the command value stored in the memory part at predetermined time intervals. The method of controlling and displaying an auxiliary traffic light includes: a first step of simultaneously turning ON the first to fifth display lamps of the auxiliary traffic light in red when a red light of the main traffic light is turned ON; a second step of turning ON the first display lamp of the auxiliary traffic light in red and simultaneously turning ON the second to fifth display lamps into left turn arrows when a left turn light of the main traffic light is turned ON; a third step of sequentially changing the second to fifth display lamps of the auxiliary traffic light from left turn arrows into yellow before the left turn light of the main traffic light is turned OFF; a fourth step of simultaneously turning ON the second to fifth display lamps of the auxiliary traffic light in yellow when a yellow light of the main traffic light is turned ON; a fifth step of simultaneously turning ON the first to fifth display lamps of the auxiliary traffic light in green when a green light of the main traffic light is turned ON; and a sixth step of sequentially changing the first to fifth display lamps of the auxiliary traffic light from green into yellow before the green light of the main traffic light is turned OFF. In the method of controlling and displaying an auxiliary traffic light, the first to sixth steps are repeatedly performed, and the first to fifth display lamps of the auxiliary traffic light have an oval shape.

### ADVANTAGEOUS EFFECTS

As described above, providing a traffic light display control system and a display method thereof in accordance with an exemplary embodiment of the present invention, it is possible to prevent traffic accidents due to unsafe entry of vehicles into a crossroad or a crosswalk, and abrupt stoppage of vehicles, possibly caused by a driver being unable to predict a time when a drive signal is changed to a stop signal while the driver drives a vehicle toward a crossroad or a crosswalk.

In addition, since a driver can accurately predict a signal change time without any confusion about a main traffic light system, it is possible for the driver to readily determine in advance whether he/she stops in front of the crossroad or crosswalk, without any apprehension.

Further, since a driver can accurately predict a signal change time and determine whether he/she stops in front of the crossroad or crosswalk, it is possible to reduce traffic delay and congestion at the crossroad, and save fuel by effectively adjusting acceleration of a moving vehicle.

### BRIEF DESCRIPTION OF THE DRAWINGS

The above and other aspects and advantages of the present invention will become apparent and more readily appreciated from the following description of exemplary embodiments, taken in conjunction with the accompanying drawings, in which:

FIG. 1 is a photograph of a conventional residual time display device of a pedestrian light;

FIG. 2 is a block diagram of an example of a conventional residual time display device of a traffic light;

FIG. 3 is a block diagram of an example of a conventional circuit of a traffic light;

FIG. 4 is a view of a traffic light display control system in accordance with an exemplary embodiment of the present invention, instructing a drive signal and a left turn signal of a traffic light display device;

FIG. 5 is a view of a traffic light display control system in accordance with an exemplary embodiment of the present invention, showing variation of a residual time display device;

FIG. 6 is a view of a traffic light display control system in accordance with an exemplary embodiment of the present invention, showing further variation of a residual time display device;

FIG. 7 is a view of a traffic light display control system in accordance with an exemplary embodiment of the present invention, showing that a yellow light is turned ON to display a crossroad entry stop signal;

FIG. 8 is a view of a traffic light display control system in accordance with an exemplary embodiment of the present invention, showing that a red light is turned ON to display a stop signal;

FIG. 9 is a block diagram of a traffic light display control system in accordance with an exemplary embodiment of the present invention;

FIG. 10 is a flowchart showing a method of performing a traffic light display control system shown in FIG. 9;

FIG. 11 is a view of a traffic light display control system in accordance with a second exemplary embodiment of the present invention;

FIGS. 12A to 12D are views of a traffic light display control system in accordance with a third exemplary embodiment of the present invention;

FIG. 13 is a view of an auxiliary traffic light separated from a main traffic light in accordance with an exemplary embodiment of the present invention; and

FIG. 14 is a view of another modification of a traffic light in accordance with the present invention.

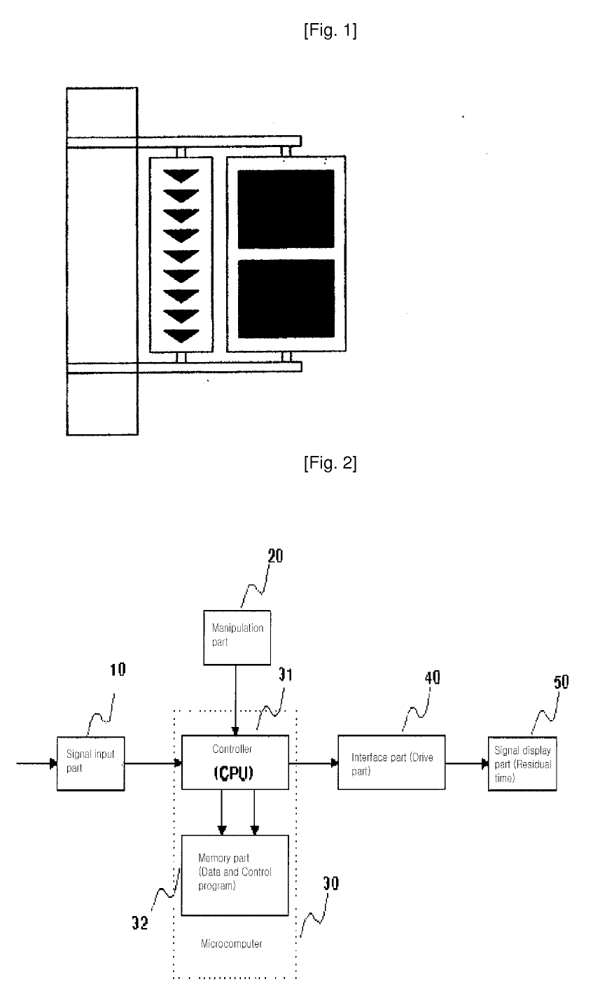

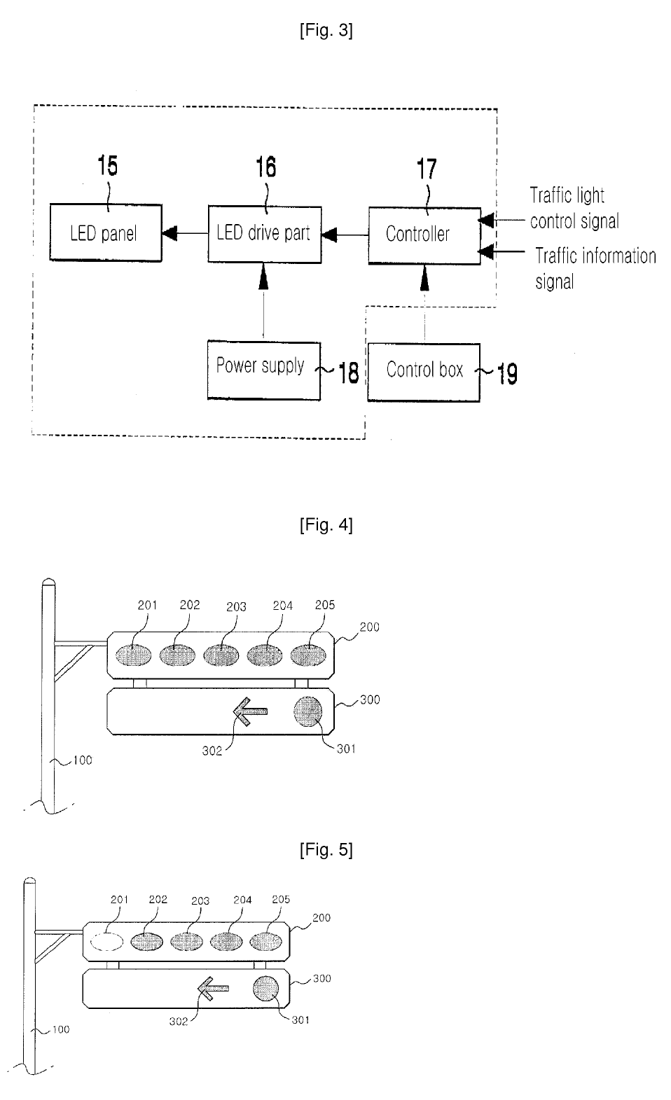

### MODE FOR THE INVENTION

Hereinafter, other objects and novel features of exemplary embodiments in accordance with the present invention will be more apparent from the following description with reference to the accompanying drawings.

First, basic concept of the present invention will be described.

A traffic light includes a red light as a vehicle stop signal, a yellow light as a prepare-to-stop signal, and a green light as a drive signal. However, since there is no device to alert drivers to a residual time to signal change, traffic accidents at crossroads and crosswalks occupy a major portion of overall traffic accidents, and can be caused by unsafe entry into the crossroad and/or the crosswalk, or by an abrupt stoppage, possibly because a driver cannot predict a time when the drive signal is changed into the stop signal while the user drives a vehicle toward the crossroad and/or the crosswalk.

In order to stop the moving vehicle at a desired position, the driver should have a sufficient stopping distance.

Generally, the stopping distance is calculated by adding an idle running distance and a braking distance. The idle running distance means a driving distance until brake force works after the driver recognizes a hazard in front of the vehicle, and the braking distance means a distance that the vehicles moves until stopping after the driver pushes a brake. Providing that an average idle running time of the driver may be about 0.6˜1 second and the vehicle may run at a speed of about 70 km˜80 km/hour on the road, a required stopping distance can be estimated at about 50 m˜60 m.

In addition, when a vehicle running at a speed of 70 km˜80 km moves 19 m˜22 m per second, the driver should be aware of a probability of signal change as the vehicle approaches the crossroad and be able to determine whether he/she goes on or stops, but since the driver cannot predict a precise time when the drive signal is changed into the stop signal while the vehicle approaches the crossroad, the probability of accidents occurring increases.

Generally, it is known that this section is started from a position before the crossroad of about 100 m, which is referred to as a “dilemma section.” Eventually, since traffic accidents at crossroads are often caused by the difficulty that a driver has in accurately predicting a signal change time of the conventional traffic light, much research has been performed in order to improve the traffic light system or develop a novel traffic light.

For example, a time display device for a traffic light is used in Korea (Korean Patent Registration No. 0543238) and the other countries in order to allow a driver to predict a signal change time. In addition, a display device for alerting drivers to a residual time between traffic lights is used in Shanghai in China, and Ulsan in Korea. However, it can be difficult for a driver to recognize the number displayed on the display device before the driver approaches the display device. Moreover, the driver should carefully watch the display device, thereby increasing probability of accidents. Therefore, the display device has not been widely distributed.

In addition, the Korean government announced on Feb. 8, 2006 that traffic light operation systems for crossroads will be changed from an American style of installing a traffic light at an opposite side of the crossroad into a European style of installing a traffic light just before the crossroad. The announcement of the Ministry of Construction and Transportation mentions that when the position of the traffic light is somewhat pulled forward, traffic accidents can be greatly decreased due to spatial and temporal margins of determining whether the vehicle runs or stops, in proportion to the pulled distance.

In fact, Jeonju City introduced the European system from 2001, and the number of traffic accidents has been substantially decreased. Though many cities in Korea operate traffic light systems applying the European system, in which a traffic light is installed at a support post installed at an opposite traffic lane and seen from a drive direction, various research and reviews are still needed to determine how much effect the European traffic light obtains in comparison with huge investment in moving the entire traffic light support post.

The European system and the American system each have advantageous effects. Since the European system installs the traffic light just before the crossroad, a vehicle stop line should also be retreated in order to obtain a visual angle of a driver, thereby lowering road efficiency.

The European traffic light is moved forward about 15˜20 m in comparison with the American traffic light. However, since the traffic light is hanging in the air without a relative material for giving perspective, as opposed to an installation structure on the ground, it is difficult for a driver operating a vehicle to recognize the pulled distance of 15˜20 m until the driver reaches about 30 m before the traffic light. Moreover, at night, at dawn and in the rain, when there is poor visibility and a high probability of traffic accidents, the effect of pulling the traffic light forward may be largely decreased.

However, the reason for adopting the European traffic light system is that a stopping distance should be about 60 m, calculated by adding an idle running distance 20 m and a braking distance 40 m, when the vehicle runs at 80 km/hour. Within a distance of more than 50˜60 m before the crossroad, it is easy for a driver to stop the vehicle at the crossroad when the traffic light is changed, regardless of the European or American system. However, within a distance less than 50˜60 m before the crossroad, since it is possible to recognize the pulled distance of the European system, as opposed to the American system, the driver can reduce the stopping distance of the vehicle by decreasing the idle running distance in which the driver reacts to stop the vehicle.

Eventually, it is impossible for the driver to accurately predict the current traffic light system such as the above systems while approaching to the crossroad. For this reason, an auxiliary apparatus may be provided to make it possible for the driver operating a vehicle to accurately and readily predict a signal change time without any confusion and aversion, thereby previously determining whether the driver goes on or stops the vehicle at the crossroad. Therefore, using the auxiliary traffic light system, it is possible to remarkably reduce traffic accidents at crossroads, at crosswalks on a straight road on which vehicles drive fast, and a curved road in which many traffic accidents occur, in comparison with the other traffic light systems, including the European system.

Hereinafter, features of the present invention will be described in comparison with the above viewpoints.

1. For example, in the constitution disclosed in Korean Patent Registration No 389452, it is impossible for a driver operating a vehicle to recognize turned OFF display lamps at night and at dawn, when only the other turned ON display lamps can be recognized. Therefore, it is impossible to know the entire ratio between the turned ON and OFF display lamps, and the residual time to signal change. In order to solve the problem, the auxiliary traffic light system in accordance with the present invention includes a plurality of display lamps capable of displaying three colors, and uses a signal display method of changing its color from green as a drive signal into yellow as a prepare-to-stop signal.

That is, the yellow light of the auxiliary traffic light sequentially encroaches on the green light of the auxiliary traffic light such that the driver can accurately predict a signal change time to the yellow light of the main traffic light and recognize a residual time of the green light of the main traffic light. In addition, the driver can relatively estimate a time interval between the traffic lights and a running distance while approaching to the crossroad to previously determine whether he/she goes on or stops the vehicle, even though the driver cannot accurately know a distance before the crossroad.

2. The auxiliary traffic light system includes five display lamps. Since a residual time display device for a pedestrian light and an auxiliary traffic light for a driver operating a vehicle fast should be readily recognized from a far distance, the larger the size of the auxiliary traffic light, the better the visual effect. Providing that a time taken to pass the crossroad from a distance of 100 m before the cross road is 5˜8 seconds (a residual time of 20 or 30 seconds is meaningless because the time means a distance of 400˜600 m before the crossroad when a vehicle runs at 70˜80 km/hour), a signal change residual time of the auxiliary traffic light is set as 5˜7.5 seconds, and a time interval to change from a yellow light to a red light of the main traffic light and the auxiliary traffic light is three seconds. As a result, it will be appreciated that the auxiliary traffic light may have five display lamps appropriate to perfectly assimilate the dilemma section of the crossroad, and the auxiliary traffic light can be distinguished from the main traffic light including four lights.

3. The auxiliary traffic light has an oval shape, and the main traffic light has a circular shape, different from the auxiliary traffic light. The auxiliary traffic light can be displayed in the same color as the traffic light such that the display lamps of the auxiliary traffic light function as the main traffic light. As a result, it is possible to provide a clearer signal to a driver to increase safety at the crossroad, especially at night, at dawn and in foggy weather.

4. The signal system of the auxiliary traffic light is interlocked with the main traffic light to be changed in the same color as a red light, a yellow light and a green light of the main traffic light. As a result, it is possible to prevent confusion of the main traffic light system due to the auxiliary traffic light, and further, the auxiliary traffic light may function as the main traffic light.

Examples of operation of the auxiliary traffic light will be described below.

When the auxiliary traffic light is installed, though there can be errors made depending on actual road conditions or traffic flow, a driver can predict whether he/she stops the vehicle at the crossroad, i.e., the driver can predict a signal change time. Therefore, there is no need to add an idle running distance to calculate a stopping distance of the vehicle, and only a braking distance is required. Korean traffic safety standards prescribe that a vehicle having a maximum speed of more than 80 km/hour should stop within a stopping distance less than 22 m at 50 km/hour in a maximum passenger capacity (maximum freight), and a vehicle having a maximum speed less than 80 km/hour should stop within a stopping distance less than 14 m at 35 km/hour. A vehicle running at 60 km/hour can stop within about 30 m, a vehicle running at 70 km/hour can stop within about 35 m, and a vehicle running at 80 km/hour can stop within about 40 m. A vehicle running at 80 km/hour on a general road with a stopping distance of about 40 m can stop within three seconds.

That is, the vehicle can stop with the stopping distance described in the following Table 1. Table 1 shows stopping distances when the auxiliary traffic light has a signal interval of 1 second. When the signal interval is 1.5 seconds, a stopping distance in each interval should be lengthened.

TABLE 1
Stopping distances depending on vehicle speed

| | 1 sec | 2 sec | 3 sec | 4 sec | 5 sec | 6 sec | 7 sec |
|---|---|---|---|---|---|---|---|
| 60 km/h | 17 m | 33 m | 50 m | 67 m | 83 m | 100 m | 117 m |
| 70 km/h | 19 m | 39 m | 58 m | 78 m | 97 m | 117 m | 136 m |
| 80 km/h | 22 m | 44 m | 67 m | 89 m | 111 m | 133 m | 156 m |

### EXAMPLE

When a vehicle goes through the crossroad and five display lamps of the auxiliary traffic light are in green, since there is at least five seconds until the main traffic light is changed into a yellow light as a prepare-to-stop signal, the driver may pass the crossroad when the vehicle is operating within a distance of 80 m before the crossroad, i.e., the dilemma section. When the green light of the auxiliary traffic light starts to be changed into yellow, it is four seconds before the main traffic light is changed into a yellow light.

1. When the vehicle runs at 60 km/hour within a distance of 60 m˜70 m before the crossroad, if a first green light of the auxiliary traffic light is changed into yellow, the driver should stop at the crossroad.

2. When the vehicle runs at 70 km/hour within a distance of 70 m˜80 m before the crossroad, if a first green light of the auxiliary traffic light is changed into yellow, the driver should stop at the crossroad.

3. When the vehicle runs at 80 km/hour within a distance of 80 m˜90 m before the crossroad, if a first green light of the auxiliary traffic light is changed into yellow, the driver should stop at the crossroad.

4. When the vehicle runs at 60 km/hour within a distance of 45 m˜50 m before the crossroad, if first and second green lights of the auxiliary traffic light are changed into yellow, the driver should stop at the crossroad.

5. When the vehicle runs at 70 km/hour within a distance of 55 m˜60 m before the crossroad, if first and second green lights of the auxiliary traffic light are changed into yellow, the driver should stop at the crossroad.

6. When the vehicle runs at 70 km/hour within a distance of 35 m˜40 m before the crossroad, if first, second and third green lights of the auxiliary traffic light are changed into yellow, the driver should stop at the crossroad.

7. When the vehicle runs at 80 km/hour within a distance of 40 m˜45 m before the crossroad, if first, second and third green lights of the auxiliary traffic light are changed into yellow, the driver should stop at the crossroad.

8. When the vehicle runs at 80 km/hour within a distance of 20 m˜25 m before the crossroad, if first, second, third and fourth green lights of the auxiliary traffic light are changed into yellow, the driver should stop at the crossroad.

A residual time display device in accordance with the present invention will be described below.

As described above, the auxiliary traffic light in accordance with the present invention is provided to perform the same function as the main traffic light. Generally, two main traffic lights are installed at a dual carriageway, and three main traffic lights are installed at a triple carriageway, and so on. The reason for installing a plurality of main traffic lights is that the driver can readily recognize the traffic light and discriminate the traffic light from the other urban illuminations, though the driver operating a vehicle does not watch a specific traffic light. Therefore, when the auxiliary traffic light is adapted to the main traffic light, two sets of the auxiliary and main traffic lights are more effective than four conventional traffic lights, thereby providing a traffic light system capable of accurately displaying clearer information and perfectly performing functions of the auxiliary traffic light.

Hereinafter, constitution of the present invention will be described with reference to the accompanying drawings.

In addition, like reference numerals refer to like elements, and their description will not be repeated.

### First Exemplary Embodiment

FIG. 4 is a view of a traffic light display control system in accordance with an exemplary embodiment of the present invention, instructing a drive signal and a left turn signal of a traffic light display device. That is, FIG. 4 illustrates a traffic light of a conventional traffic system for instructing a drive or left turn signal, a green light of which is turned ON.

In FIG. 4, reference numeral 100 designates a traffic light support post installed at a general road, reference numeral 200 designates an auxiliary traffic light as a first display part in accordance with the present invention, and reference numeral 300 designates a main traffic light as a second display part used in the conventional traffic light system.

In addition, the auxiliary traffic light 200 includes first to fifth display lamps 201, 202, 203, 204 and 205. The main traffic light 300 includes a plurality of display lamps. The first to fifth display lamps 201 to 205 of the auxiliary lamps and the respective display lamps of the auxiliary traffic light are formed of light emitting means such as a light emitting diode (LED) used in the conventional traffic light. That is, as described above, the present invention provides the auxiliary traffic light 200 including the five display lamps having an oval shape such that a driver can clearly and accurately recognize the display lamps.

Further, as described above, considering that the first to fifth display lamps 201 to 205 of the auxiliary traffic light emit the same color as the main traffic light, the display lamps of the auxiliary traffic light 200 have an oval shape, as opposed to the main traffic light 300 having a circular shape. Since the auxiliary traffic light emits the same color of light as the main traffic light, the auxiliary traffic light may enable the same effect as the main traffic light. Therefore, the first to fifth display lamps 201 to 205 of the auxiliary traffic light 200 make it possible for a driver to clearly recognize the traffic light when there is poor visibility, especially at night, at dawn, in the rain and in foggy weather.

Furthermore, in FIG. 4, reference numeral 301 designates a green light disposed in the main traffic light 300 and displaying a drive signal, reference numeral 302 designates a green arrow disposed in the main traffic light 300 and displaying a left turn signal. An example showing features of an embodiment in accordance with the present invention is shown in FIG. 4, but is not limited thereto.

FIG. 5 is a view of a traffic light display control system in accordance with an exemplary embodiment of the present invention, showing variation of a residual time display device.

Specifically, FIG. 5 illustrates the traffic light shown in FIG. 4, where the first display lamp 210 of the auxiliary traffic light 200 is turned ON in yellow to predict a stop signal after displaying a drive signal and a left turn signal.

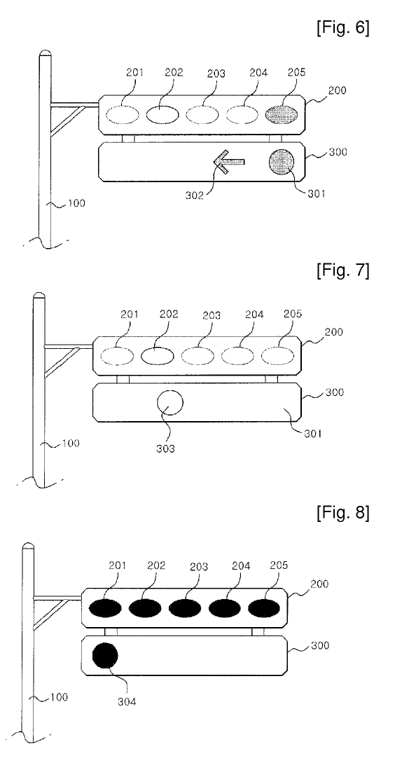

FIG. 6 is a view of a traffic light display control system in accordance with an exemplary embodiment of the present invention, showing further variation of a residual time display device.

Specifically, FIG. 6 illustrates the traffic light shown in FIG. 5, where the first to fourth display lamps 201 to 204 of the auxiliary traffic light 200 are turned ON in yellow to alert drivers to the prepare-to-stop signal after displaying the drive signal and the left turn signal.

FIG. 7 is a view of a traffic light display control system in accordance with an exemplary embodiment of the present invention, showing that a yellow light is turned ON to display a crossroad entry stop signal.

Specifically, FIG. 7 illustrates the traffic light shown in FIG. 6, the drive signal and the left turn signal of the main traffic light being turned OFF, and the first to fifth display lamps 201 to 205 of the auxiliary traffic light 200 and a yellow light 303 of the main traffic light being turned ON in yellow to display a prepare-to-stop signal to more surely alert drivers to a prepare-to-stop signal.

FIG. 8 is a view of a traffic light display control system in accordance with an exemplary embodiment of the present invention, showing that a red light is turned ON to display a stop signal.

Specifically, FIG. 8 illustrates the traffic light shown in FIG. 7, after alerting drivers to the prepare-to-stop signal, the first to fifth display lamps 201 to 205 of the auxiliary traffic light 200 and a red light 304 of the main traffic light being turned ON in red to display a stop signal.

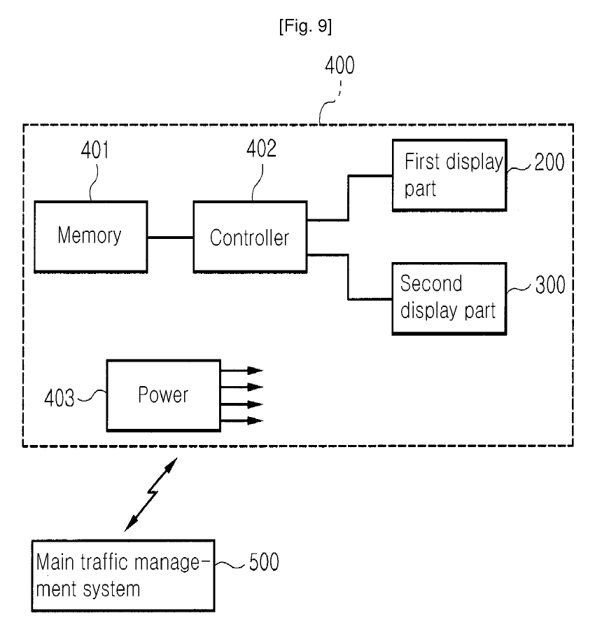

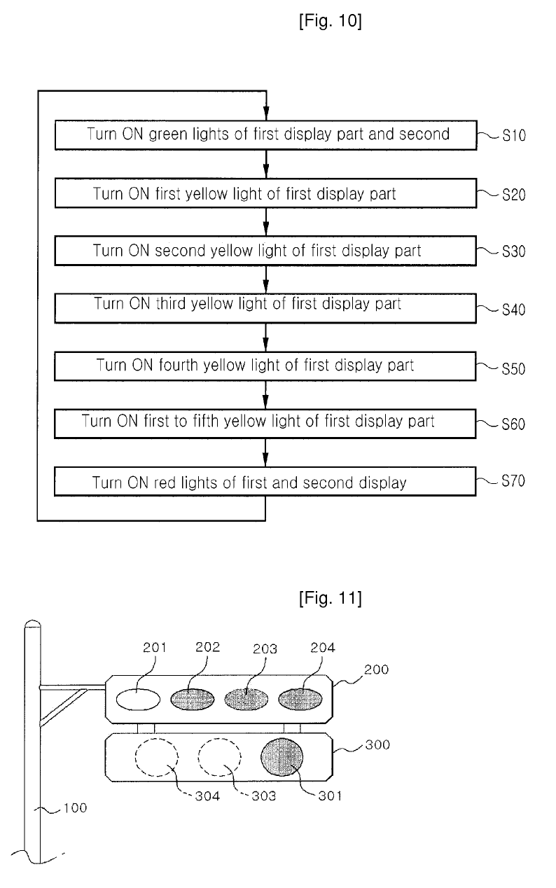

Hereinafter, the traffic light control system shown in FIGS. 4 to 8 and a method of displaying a traffic light system will be described with reference to FIGS. 9 and 10.

FIG. 9 is a block diagram of a traffic light display control system in accordance with an exemplary embodiment of the present invention, and FIG. 10 is a flowchart showing a method of performing a traffic light display control system shown in FIG. 9.

In FIG. 9, the traffic light display control system 400 installed at a general road and controlling a traffic light as shown in FIG. 4 includes a memory part 401 for storing a command value for turning ON/OFF the display lamps of a first display part 200 as an auxiliary traffic light and a second display part 300 as a main traffic light at predetermined time intervals, a controller 402 for controlling to turn ON/OFF the first display part 200 as the auxiliary traffic light and the second display part 300 as the main traffic light depending on the command value stored in the memory part 402, and a power supply 403 for supplying power required to each component of the traffic light display control system 400.

In addition, reference numeral 500 designates a main traffic management system installed at a central control station and remotely controlling the traffic light display control system 400 installed at each road in accordance with the present invention. Specifically, the main traffic management system 500 remotely controls a display interval of each display lamp of the traffic light display control system 400 installed at each road depending on a traffic flow of the road, thereby maintaining a smooth traffic flow of the road.

Hereinafter, a method of displaying the traffic light display control system 400 shown in FIGS. 4 and 9 will be described with reference to FIG. 10.

First, a green light 301 of a main traffic light 300 as a second display part is turned ON according to a traffic light display method of a main traffic management system 500 (S10). That is, as shown in FIG. 4, first to fifth display lamps 201 to 205 of an auxiliary traffic light 200 as a first display part, a green light 301 of a main traffic light as a second display part, and a green arrow 302 as a left turn signal are simultaneously turned ON.

In addition, as shown in FIG. 4, the green light 301 as a drive signal and the green arrow 302 as a left turn signal may be sequentially turned ON depending on an installation place of the traffic light. However, the green light 301 as the drive signal and the green arrow 302 as the left turn signal, which are simultaneously turned ON, will not be described for the convenience of description.

Next, after a predetermined time elapses, that is, after the turn-ON time of the traffic lamp set by the main traffic management system 500 according to traffic flow of a road in which the traffic light display control system 400 elapses, as shown in FIG. 5, the first display lamp 201 of the auxiliary traffic light 200 is turned ON in yellow as a preliminary step of turning OFF the green light 301 as the drive signal and the green arrow 302 as the left turn signal (S20). Even at this time, the green light 301 as the drive signal and the green arrow 302 as the left turn signal of the main traffic light 300 are maintained in a turned-ON state.

Next, after a predetermined time elapses, the second display lamp 202 of the auxiliary traffic light 200 is turned ON in yellow (S30). Even at this time, the green light 301 as the drive signal and the green arrow 302 as the left turn signal of the main traffic light 300 are maintained in a turned ON state.

Then, after a predetermined time set by the main traffic management system 500 and the memory part 401 of the traffic light display control system 400 elapses, the third display lamp 203 of the auxiliary traffic light 200 is turned ON in yellow (S40). Even at this time, the green light 301 as the drive signal and the green arrow 302 as the left turn signal of the main traffic light 300 are maintained in a turned ON state.

Continuously, after a predetermined time elapses, the fourth display lamp 204 of the auxiliary traffic light 200 is turned ON in yellow (S50), and green light 301 as the drive signal and the green arrow 302 as the left turn signal of the main traffic light 300 are maintained in a turned ON state.

Next, as shown in FIG. 7, a yellow light of the main traffic light is turned ON in order to stop entry of a vehicle into the crossroad for the purpose of driving straight through or taking a left turn. Specifically, the first to fifth display lamps 201 to 205 of the auxiliary traffic light 200 as the first display part and the yellow light 303 of the main traffic light 300 as the second display part are turned ON in yellow (S60).

Then, after a predetermined time set by the main traffic management system 500 and the memory part 401 of the traffic light display control system 400 elapses, as shown in FIG. 8, a red light is turned ON in order to stop a drive-through and a left turn of a driver. Specifically, the first to fifth display lamps 201 to 205 of the auxiliary traffic light 200 as the first display part and a red light 304 of the main traffic light 300 as the second display part are turned ON in red (S70).

As described above, a display interval of the display lamp can be remotely controlled by the main traffic management system 500 on the basis of traffic flow of a road on which the traffic light display control system 400 is installed, thereby maintaining a smooth traffic flow.

### Second Exemplary Embodiment

FIG. 11 is a view of a traffic light display control system in accordance with a second exemplary embodiment of the present invention.

Specifically, the second embodiment is similar to the first embodiment, except that an auxiliary traffic light 200 includes first to fourth display lights 201 to 204, and a main traffic light 300 has no green arrow 302 as a left turn signal.

In addition, in the second embodiment, considering that the first to fourth display lamps 201 to 204 of the auxiliary traffic light 200 emit the same color of light as the main traffic light, the display lamps of the auxiliary traffic light 200 have an oval shape, as opposed to the main traffic light 300 having a circular shape. Since the aux iliary traffic light emits the same color of light as the main traffic light, the auxiliary traffic light may perform the same effect as the main traffic light.

Therefore, the second embodiment can obtain the same effect as the first embodiment.

### Third Exemplary Embodiment

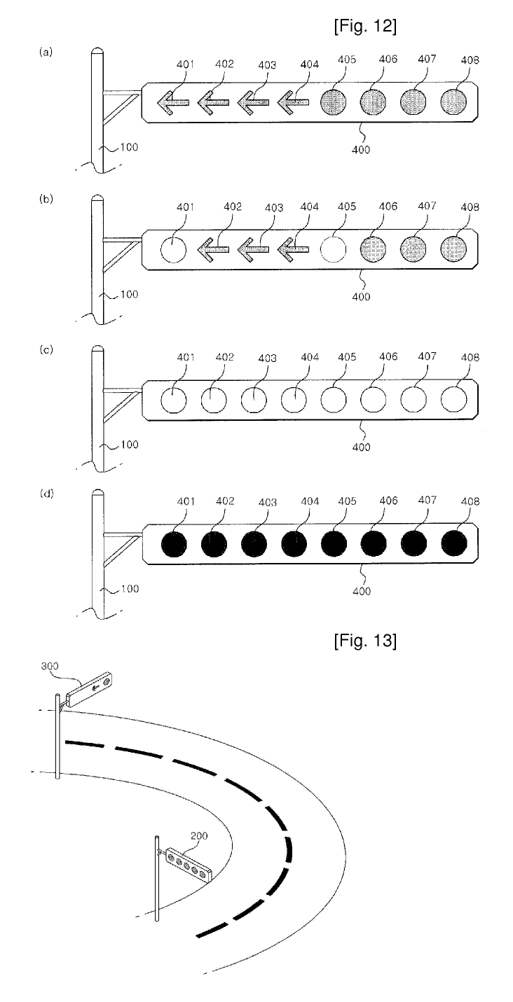

FIGS. 12A to 12D are views of a traffic light display control system in accordance with a third exemplary embodiment of the present invention.

In FIGS. 12A to 12D, reference numeral 100 designates a traffic light support post installed at a road, reference numeral 400 designates a traffic light used in a general traffic light system and including first and second display parts. Reference numerals 401 to 404 designate the first display part, and reference numerals 405 to 408 designate the second display part.

Therefore, the first and second display parts are constituted of first to eighth display lamps. In FIG. 12A, the first to fourth display lamps 401 to 404 of the first display part emit left turn signals, and the fifth to eighth display lamps 405 to 408 of the second display part emit a drive or stop signal. That is, the third embodiment includes a main traffic light and an auxiliary traffic light, which are installed in a single row, as opposed to the first and second embodiments.

Operation of the third embodiment will be described with reference to FIGS. 12A to 12D in below.

First, as shown in FIG. 12A, the display lamps of the traffic light 400 are turned ON in green according to a traffic light display method of a main traffic management system 500. Specifically, the first to fourth display lamps 401 to 404 of the first display part are turned ON in green as left turn signals, and simultaneously, the fifth to eighth display lamps 405 to 408 of the second display part are turned ON in green as drive signals.

In addition, as shown in FIG. 4, the green lights 405 to 408 as the drive signal and the green arrows 401 to 404 as the left turn signal may be sequentially turned ON depending on an installation place of the traffic light.

Next, after a predetermined time elapses, that is, after a turned ON time of the traffic light set by the main traffic management system 500 depending on traffic flow of an installation plate of the traffic light display control system 400 elapses, as shown in FIG. 12B, the first display lamp 401 and the fifth display lamp 405 are turned ON in yellow as a preliminary step of turning OFF the green lights 405 to 408 as the drive signal and the green arrows 401 to 404 as the left turn signals. Even at this time, the other display lamps except the first and fifth display lamps 401 and 405 are maintained in a turned ON state, with the green lights as the drive signals, and the green arrows as the left turn signals.

After a time set by the main traffic management system 500 and the memory part 401 of the traffic light display control system 400 elapses, as shown in FIG. 12C, all the display lamps of the first display part and the second display part are turned ON in yellow in order to stop entry of the vehicles into the crossroad for the purpose of driving straight through or taking a left turn.

After a time set by the main traffic management system 500 and the memory part 401 of the traffic light display control system 400 elapses, as shown in FIG. 12D, all the display lamps of the first display part and the second display part are turned ON in yellow in order to stop the drive through or the left turn.

Of course, the display interval of the traffic light may be remotely controlled by the main traffic management system 500 depending on traffic flow of the road, in which the traffic light display control system is installed, thereby maintaining a smooth traffic flow.

FIG. 13 is a view of an auxiliary traffic light separated from a main traffic light in accordance with an exemplary embodiment of the present invention.

Specifically, FIG. 13 illustrates the traffic light system of FIG. 4, the main traffic light and the auxiliary traffic light being separated from each other.

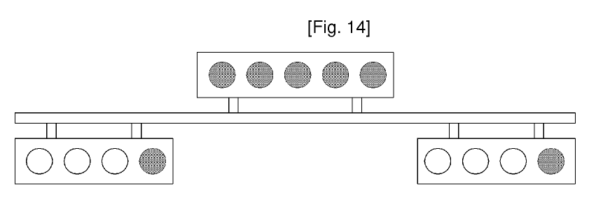

FIG. 14 is a view of another modification of a traffic light in accordance with the present invention.

At least 80% of domestic traffic accidents occur at crossroads and crosswalks. Among them, at least 50% of the traffic accidents at the crossroads and the crosswalks occur at crossroads and crosswalks on a curved or sloped road as shown in FIG. 13. In particular, accidents on the curved or sloped road are likely to be a multi-crash, in comparison with the accident at the straight road.

This is because it is difficult to watch the traffic light on the curved road, and instantly control the vehicle speed according to a signal change of the traffic light at the sloping road, thereby causing rapid acceleration or rapid braking.

In order to reduce traffic accidents at the above places, the auxiliary traffic light performing the same function as the main traffic light or a yellow blinker may be installed before the curved crossroad, thereby attracting a driver's attention. However, the above method merely alerts the driver's attention to the fact that the crossroad exists ahead. Once the driver passes through the auxiliary traffic light or the yellow blinker, the driver should determine again to go or stop depending on instruction of the traffic light at the crossroad, regardless of the auxiliary traffic light. Therefore, the effect of the auxiliary traffic light or the yellow blinker is not great enough to prevent the traffic accident.

Since the auxiliary traffic light is installed at about 50 m˜100 m before the main traffic light of the crossroad and it is impossible for the driver to predict a residual time of the main traffic light of the crossroad from the auxiliary traffic light and determine the traffic state of the crossroad, the probability of traffic accidents at the curved or sloped road is still high.

In addition, when the auxiliary traffic light having the same structure as the main traffic light is in front of the main traffic light of the crossroad, since it is difficult to discriminate the auxiliary traffic light from the main traffic light at the crossroad, especially at night, at dawn, and in bad weather, the driver may misjudge the actual crossroad position, thereby increasing the probability of another traffic accident occurring.

In order to solve the above problem, the auxiliary traffic light in accordance with the present invention includes five display lamps having an oval shape and capable of displaying four signals such as a red light, a yellow light, a green arrow and a green light using each lamp, in comparison with the conventional traffic light having a circular shape and includes a red light, a yellow light, a green arrow and a green light, which can emit a single color only. While the conventional traffic light displays each signal using a single light, since the five display lamps of the auxiliary traffic light in accordance with the present invention are turned ON in the same color, it is possible to clearly discriminate the auxiliary traffic light. In addition, since the five display lamps of the auxiliary traffic light are sequentially turned ON/OFF, it is possible for a driver to accurately predict a signal change time of the main traffic light of the crossroad.

In addition, the auxiliary traffic light in accordance with the present invention has a shape different from the conventional traffic light and the same operation manner as the main traffic light in accordance with the present invention. Therefore, though the driver cannot watch the traffic light of the crossroad on the curved road, the driver can recognize the traffic light of the crossroad before the curved road. Especially, while the auxiliary traffic light is installed in front of the crossroad, it is possible for the driver to discriminate the auxiliary traffic light, without any confusion of the crossroad position, even at night, at dawn and in bad weather. Further, since the driver can predict a signal change time from the drive signal to the stop signal, it is possible to prevent rapid braking and rapid acceleration on the curved road or the sloped road, and thus, prevent traffic accidents on roads where many accidents generally occur.

Although the present invention has been described with reference to certain exemplary embodiments thereof, it will be understood by those skilled in the art that a variety of modifications may be made to the described embodiments without departing from the spirit or scope of the present invention defined by the appended claims and their equivalents.

### INDUSTRIAL APPLICABILITY

As can be seen from the foregoing, the present invention is advantageous in a traffic light display control system.

1. A display control system of a traffic light controlled by a central control station and installed at each road, the system comprising:
an auxiliary traffic light as a first display part;
a main traffic light as a second display part used in a conventional traffic light system;
a memory part for storing a command value for turning ON and OFF each display lamp of the auxiliary traffic light and the main traffic light at pre-determined time intervals; and
a controller for controlling to turn ON and OFF the auxiliary traffic light and the main traffic light at predetermined time intervals depending on the command value stored in the memory part,
wherein the auxiliary traffic light is installed over the main traffic light,
the auxiliary traffic light comprises first to fourth display lamps,
the first to fourth display lamps of the auxiliary traffic light are all turned ON in the same color when the main traffic light is red, arrow, yellow or green, and the display lamps are sequentially changed from green into yellow to thereby block entry of a vehicle into a crossroad before a drive signal of the main traffic light is changed,
the auxiliary traffic light further comprises a fifth display lamp,
the first to fifth display lamps are sequentially changed from green into yellow to block entry of a vehicle into a crossroad,
the main traffic light has a circular shape, and
the first to fifth display lamps of the auxiliary traffic light have an oval shape.

2. The traffic light display control system according to claim 1, wherein, when the green light of the main traffic light is turned ON, the first to fourth display lamps of the auxiliary traffic light are sequentially turned ON in yellow.

3. The traffic light display control system according to claim 1, wherein, when the yellow light of the main traffic light is turned ON, the first to fifth display lamps of the auxiliary traffic light are simultaneously turned ON in yellow.

4. The traffic light display control system according to claim 1, wherein, when the red light of the main traffic light is turned ON, the first to fifth display lamps of the auxiliary traffic light are simultaneously turned ON in red.

5. A display control system of a traffic light controlled by a central control station and installed at each road, the system comprising:
a traffic light having first and second display parts and used in a conventional traffic light system;
a memory part for storing a command value for turning ON and OFF each display lamp of the traffic light at predetermined time intervals; and
a controller for controlling to turn ON and OFF the traffic light at predetermined time intervals depending on the command value stored in the memory part,
wherein the first and second display parts comprise first to eighth display lamps, the first to fourth display lamps of the first display part are left turn instruction lights,
the fifth to eighth display lamps of the second display part are drive instruction lights, and
the first to eight display lamps of the traffic light are sequentially turned ON in order of the first to fourth display lamps of the first display part and the fifth to eight display lamps of the second display part in yellow simultaneously with turning OFF of a left turn light and a green light so as to block entry of a vehicle into a crossroad.

6. A display method of a display control system of a traffic light controlled by a central control station and installed at each road, which comprises an auxiliary traffic light as a first display part having first to fifth display lamps, a main traffic light as a second display part used in a conventional traffic light system, a memory part for storing a command value for turning ON and OFF each display lamp of the auxiliary traffic light and the main traffic light at predetermined time intervals, and a controller for controlling to turn ON and OFF the auxiliary traffic light and the main traffic light at predetermined time intervals depending on the command value stored in the memory part,
the method comprising:
a first step of simultaneously turning ON the first to fifth display lamps of the auxiliary traffic light in red when a red light of the main traffic light is turned ON;
a second step of turning ON the first display lamp of the auxiliary traffic light in red and simultaneously turning ON the second to fifth display lamps into left turn arrows when a left turn light of the main traffic light is turned ON;
a third step of sequentially changing the second to fifth display lamps of the auxiliary traffic light from left turn arrows into yellow before the left turn light of the main traffic light is turned OFF;
a fourth step of simultaneously turning ON the second to fifth display lamps of the auxiliary traffic light in yellow when a yellow light of the main traffic light is turned ON;
a fifth step of simultaneously turning ON the first to fifth display lamps of the auxiliary traffic light in green when a green light of the main traffic light is turned ON; and
a sixth step of sequentially changing the first to fifth display lamps of the auxiliary traffic light from green into yellow before the green light of the main traffic light is turned OFF,
wherein the first to sixth steps are repeatedly performed,
the main traffic light has a circular shape, and
the first to fifth display lamps of the auxiliary traffic light have an oval shape.

7. An auxiliary traffic light for predicting a signal change spaced apart from a main traffic light by a predetermined distance to alert drivers to a state of the main traffic light controlled by a central control station and installed at each road, the auxiliary traffic light comprising:
a memory part for storing a command value for turning ON and OFF display lamps of the auxiliary traffic light and the main traffic light at predetermined time intervals; and
a controller for controlling to turn ON and OFF the auxiliary traffic light and the main traffic light depending on the command value stored in the memory part at predetermined time intervals,
wherein the auxiliary traffic light comprises first to fifth display lamps,
the first to fifth display lamps of the auxiliary traffic light are all turned ON in the same color when the main traffic light is red, arrow, yellow or green, and the display lamps are sequentially changed from green into yellow to block entry of a vehicle into a crossroad before a drive signal of the main traffic light is changed,
the first to fifth display lamps are sequentially turned ON in yellow simultaneously with turning OFF the green light to block entry of a vehicle into a crossroad, and
the first to fifth display lamps of the auxiliary traffic light have an oval shape.

8. A display method of an auxiliary traffic light for predicting a signal change which are spaced apart from a main traffic light by a predetermined distance to alert drivers to a state of the main traffic light installed at the road, and comprises first to fifth display lamps, a memory part for storing a command value for turning ON and OFF display lamps of the auxiliary traffic light at predetermined time intervals, and a controller for controlling to turn ON and OFF the auxiliary traffic light depending on the command value stored in the memory part at pre-determined time intervals,
the method comprising:
a first step of simultaneously turning ON the first to fifth display lamps of the auxiliary traffic light in red when a red light of the main traffic light is turned ON;
a second step of turning ON the first display lamp of the auxiliary traffic light in red and simultaneously turning ON the second to fifth display lamps into green arrows when a left turn light of the main traffic light is turned ON;
a third step of changing the second to fifth display lamps of the auxiliary traffic light from green arrows into yellow before the left turn light of the main traffic light is turned OFF;
*a fourth step of simultaneously turning ON the second to fifth display lamps of the auxiliary traffic light in yellow when a yellow light of the main traffic light is turned ON;
a fifth step of simultaneously turning ON the first to fifth display lamps of the auxiliary traffic light in green when a green light of the main traffic light is turned ON; and
a sixth step of changing the first to fifth display lamps of the auxiliary traffic light from green into yellow before the green light of the main traffic light is turned OFF,
wherein the first to sixth steps are repeatedly performed, and
the first to fifth display lamps of the auxiliary traffic light have an oval shape.
